(19) United States
(12) Patent Application Publication
(10) Pub. No.: US 2024/0289682 A1
(43) Pub. Date: Aug. 29, 2024

(54) SERIES AUGMENTATION FOR DRIFT DATASET COMPOSITION

(71) Applicant: Dell Products L.P., Round Rock, TX (US)

(72) Inventors: Herberth Birck Fröhlich, Florianópolis (BR); Ítalo Gomes Santana, Rio de Janeiro (BR); Julia Drummond Noce, Rio de Janeiro (BR); Vinicius Michel Gottin, Rio de Janeiro (BR)

(21) Appl. No.: 18/175,331

(22) Filed: Feb. 27, 2023

(51) Int. Cl. G06N 20/00

(52) U.S. Cl. CPC G06N 20/00

(57) ABSTRACT

One example method, which may be performed by a drift upsampling pipeline, includes receiving, by a drift upsampling pipeline, input including both a time series of data expressed as an initial drift curve, and a drift characterization of the drift curve. The method further includes, performing a first upsampling stage on the time series of data to generate a first family of new drift curves based on the drift characterization of the initial drift curve, performing a second upsampling stage to determine respective frequencies of the first family of new drift curves to generate a second family of new drift curves with the respective frequencies, performing a third upsampling stage on respective noise levels of the second family of new drift curves to generate a third family of new drift curves with new respective noise levels, and outputting the third family of new drift curves.

### FIELD OF THE INVENTION

Embodiments of the present invention generally relate to drift detection in ML (machine learning) models. More particularly, at least some embodiments of the invention relate to systems, hardware, software, computer-readable media, and methods, for generating datasets for use in training drift detectors.

### BACKGROUND

Drift refers to the quality degradation of machine learning (ML) models over time and it is originated from changes in the input distribution, that is, the relation between the input to the model and the output generated by the model. Since any data distribution is susceptible to changes, traditional drift detection methods work by monitoring inputs and outputs of ML models. Due to the relevance of these methods in capturing shifts in data, extensive research has been conducted on a wide number of practical use cases.

Thus, datasets for developing, validating, and testing drift detection approaches are desirable and valuable. Presently, there are real-world datasets largely used as benchmarks in relevant scientific papers. These include CoverType, PokerHand, and StatLog. However, these datasets are usually bounded to a particular domain application, which is commonly limited to only a few patterns in the data.

Other benchmarks are built using off-the-shelf tools, such as MOA and ScikitMultiFlow, to generate datasets with drift using predefined distributions. However, these methods require the parametrization of many input parameters, and a substantial amount of experimentation to achieve the results of interest. It becomes even more expensive, sometimes prohibitively, to deal with these dataset generation tools if the four main types of drift, namely, sudden, gradual, incremental, and recurring, are all considered at the same time.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of a pipeline, according to one embodiment.

FIG. 2 discloses aspects of different types of drift.

FIG. 3 discloses an example algorithm for converting a hand-drawn drift curve, according to an embodiment.

FIG. 4 discloses an example hand drawn drift curve, and corresponding drift curve generated based on the hand-drawn curve, according to an embodiment.

FIG. 5 discloses aspects of an example upsampling stage for some example values of N, according to an embodiment.

FIG. 6 discloses an example drift curve exhibiting incremental drift.

FIG. 7 discloses multiple generations of drift length according to a normal distribution.

FIG. 8 discloses multiple generations of drift length according to a uniform distribution.

FIG. 9 discloses example processes for increasing, and decreasing, a drift length,

according to an embodiment.

FIGS. 9a, 9b, and 9c, disclose further details for an example drift length increase process.

FIG. 10 discloses an example of frequency upsampling, according to one embodiment.

FIG. 11 discloses an example progression of drift curve augmentation, according to an embodiment.

FIG. 12 discloses an example computing entity configured and operable to perform any of the disclosed methods, processes, and operations.

### DETAILED DESCRIPTION OF SOME EXAMPLE EMBODIMENTS

Embodiments of the present invention generally relate to drift detection in ML (machine learning) models. More particularly, at least some embodiments of the invention relate to systems, hardware, software, computer-readable media, and methods, for generating datasets for use in training drift detectors.

One example embodiment of the invention comprises a method that generates datasets for training drift detectors by augmenting sample series and automated transformations. In particular, the input of one such method is a univariate time series obtained from an application, or retrieved from historical data. Various transformations may then be applied to this time series in different aspects to derive a family of similar curves. This resulting set of curves may then be used to train a drift detection method of interest. In an embodiment, the method may also comprise an “image-to-series” tool that may be employed to generate a curve, such as if no curve is unavailable. This tool may operate by converting a hand-made drawing of a curve to a time series and, in this way, an embodiment may introduce viewpoints, as embodied in a hand-drawn curve for example, of non-technical experts into the application.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment of the invention is that an arbitrary drift model may be built that encompasses multiple different scenarios for consideration by a drift model. An embodiment may generate a drift model using a dataset that comprises only a single drift curve. An embodiment may generate a drift model that considers the input of both experts and non-experts in the domain(s) of interest. An embodiment may generate a time series from input that is in various forms, including a hand-drawn form. Various other advantages of example embodiments will be apparent from this disclosure.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

### A. General Aspects of an Example Embodiment

In general, an embodiment may perform various useful functions not presently found in the art. For example, an embodiment may provide for the augmentation of an acquired dataset so as to generate enough samples to capture the adequate time frame of drift. This may avoid the need for the costly acquisition of datasets that inherently possess adequate data samples, since the augmentation process, according to one embodiment, may be faster, and less expensive, than such data acquisition processes. As another example, an embodiment may overcome the problem that representative benchmarks are not generally available to most domains, and those benchmarks may not express appropriate patterns and drift types. Finally, an embodiment may reduce, or eliminate, the need for the parameterizations typically required for synthetic data generation. Thus, an embodiment may serve to reduce or avoid the heavy computational overhead associated with such parameterizations, as well as reducing the burden imposed on domain specialists by such parameterization processes. It is noted that although certain aspects of one embodiment may be relatively straightforward and/or may offer simpler results in comparison to conventional low-level tools and libraries, the combination of techniques in an embodiment, and especially the trade-offs obtained by such an embodiment, particularly with respect to human effort, are not believed to be implemented or provided by any presently existing approach.

One example embodiment of the invention may be directed to method that comprises deriving a family of curves from a sample series and transformations, thus capturing the intuitions of domain specialists about possible drift scenarios in the domain, quickly and easily. The resulting augmented series may be used to train drift detectors and/or to provide diversified scenarios in the training of ML models.

In an embodiment, an augmentation module receives a time series expressing a basic drift pattern, which is then subjected to several transformations concerning parameters such as, but not limited to, typical frequency, drift length and noise level variations. For simplification, an embodiment may enable the user to control the variance interval of each transformation. Briefly, a family of related curves may be generated by these transformations, and those curves may then be used as a ‘recipe’ to generate datasets. Following is a brief description of some example transformations that may be applied in an embodiment of the invention.

One transformation that may be applied by an embodiment of the invention is drift length. As used herein, ‘drift length’ comprises, but is not limited to, an interval that starts from the beginning of the drift until the end of the drift. An embodiment may use an off-the-shelf drift detector to check where the drift starts and ends, and such embodiment may, if a drift length transformation is to be applied, shorten, or lengthen, the drift. Another example transformation is frequency. As used herein, ‘frequency’ embraces, but is not limited to, the number of points to be added to an original curve associated with a dataset. A final example transformation is noise level. Particularly, an embodiment may add noise to an original curve to introduce difficulty into the drift detector training. In an embodiment, an actual noise level may be calculated, and the augmentation, with additional noise, may begin at this calculated actual noise value.

As will be apparent from this disclosure, one or more embodiments of the invention may comprise various aspects. For example, an embodiment may comprise a method that turns a single sample series into a family of curves. As another example, an embodiment may comprise a method that receives a drawing, such as a hand drawing, of a curve and converts the drawing into a time series. By performing one or more of these functions, an embodiment may provide various benefits including, but not limited to: [1] construction of an arbitrary drift model that would be difficult to achieve using off-the-shelf data tools; [2] enabling domain experts to easily express their knowledge regarding the types of drifts in the domain of interest; and [3] saving time by generating many possibilities, or scenarios, from a single curve, together with ground truths.

### B. Detailed Description

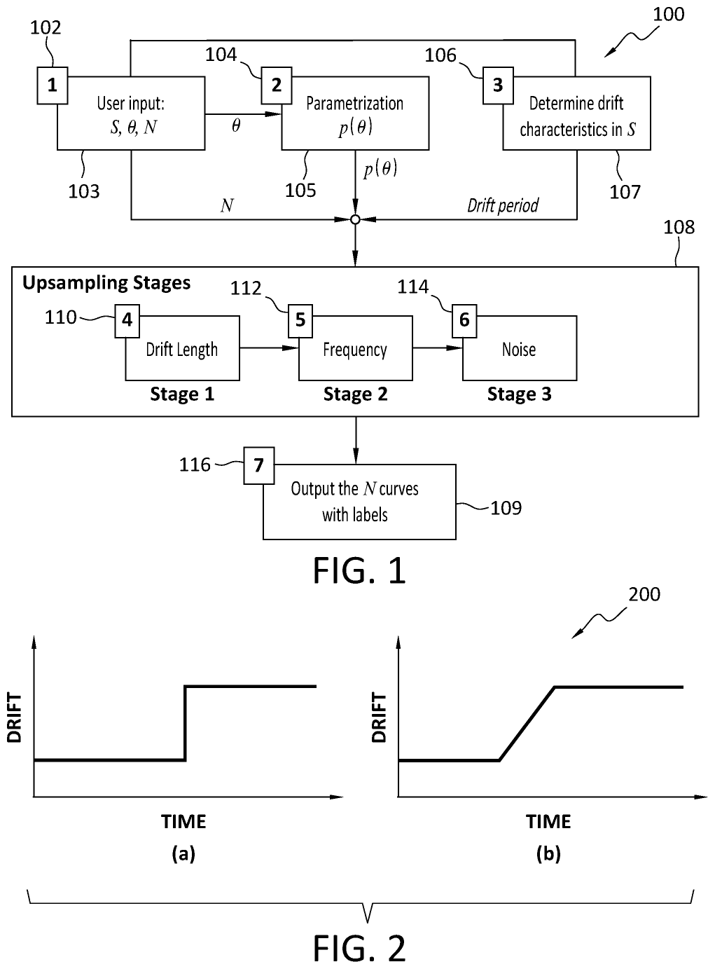

With attention now to FIG. 1, there is disclosed an example pipeline 100 according to one embodiment of the invention. As shown, the pipeline 100 may comprise various operations 1 through 7.

The first operation 102 may comprise an input operation. In an embodiment, input 103, which may comprise user-provided input, may comprise a time series S dataset expressing, in the form of a curve for example, a fully developed drift pattern. The user may provide distributions 0 for the parametrizations, discussed below, and the desired number of curves N to generated. Note that in an embodiment, a dataset may generalize during training, that is, the dataset may grow in size to cover multiple different scenarios or conditions, and this generalization of the dataset may be enabled to a greater or lesser extent, depending upon the number of curves N that are to be generated. In general then, a greater number N of curves may correspond to a more generalized, and thus larger, dataset than a dataset associated with a smaller number N of curves.

If a time series representing a basic drift pattern is not readily available, an embodiment of the invention may be used to receive hand drawing of a curve and convert the curve into the appropriate timestamped time series format. The drawing may be designed in any drawing software. In this way, personnel such as a non expert in a particular domain may be able to provide input, such as a hand drawn curve, that may be used to generate a family of N curves.

As further indicated in FIG. 1, in an embodiment, a user may provide a distribution θ for the transformations. If no boundaries for the distribution are given, default values, such as may be derived from analysis of previous scenarios, for example, may be used. Finally, a user may specify, at 102, a number N of curves to be generated. A default value may be predefined in case N is not specified. The default value may comprise, for example, a power of 2 value, as disclosed elsewhere herein.

At 104, a parameterization operation may be performed. In general, the parameterization may comprise obtaining, from an original input curve, respective averages for each parameter of a group of parameters, and then defining a standard deviation for the values of the parameters. The averages and standard deviations may be provided by a user. As shown, the parameterization p(θ) process may comprise application of a function P over the distribution θ. In general, the parameterization operation 104 may comprise drawing boundaries and parameters, collectively indicated at 105, for each upsampling stage, discussed below, of the pipeline 100, from the provided distributions.

Next, at 106, the drift characteristics 107 in the time series S dataset may be defined. This may be referred to as a drift characterization operation. In an embodiment, the drift characteristics 107 that are defined may comprise, but are not limited to, the interval, or length, of the drift period. In the event that a user provides provide the relevant drift characteristics directly, a drift detection method may be used to determine these characteristics from the original curve. Note that the operations 102, 104, and 106, may collectively form an initial processing stage of a drift upsampling pipeline, and the output of the initial processing stage may be provided as input to an upsampling section of the drift upsampling pipeline, as discussed in further detail below.

With continued reference to FIG. 1, the respective outputs N, p(θ), and drift period, from the various operations 102, 104, and 106, may be provided to an upsampling section 108 of a drift upsampling pipeline. In an embodiment, three upsampling stages 110, 112, and 114, each corresponding to a respective transformation, may be employed. The upsampling stages 110, 112, and 114, may, or may not, be implemented in series beginning with the upsampling stage 110, progressing to upsampling stage 112, and finishing with the upsampling stage 114.

In the first upsampling stage 110, concerning drift length, one or more new curves may be generated from the original series considering the parametrization performed at 104. The number of new curves may be up to N curves, as defined at 102, and may be based on the drift interval determined at 106.

In the next upsampling stage 112, relating to frequency, the N curves may be upsampled, in consideration of the frequency. That is, new curves are generated from curves generated at step 110, and considering the parameters from the operation at 104. As noted earlier, the frequency may comprise the number of points to be added to an original curve associated with a dataset.

At the upsampling stage 114, the N curves may be upsampled with respect to noise.

In particular, new curves may be generated from the curves generated at 112, and considering the parameters from 104.

With continued reference to FIG. 1, the group 108 of upsampling stages may generate 116 an output 109 comprising the resulting N new curves, together with binary labels assigning a value 1 for the observations associated to concept transition, and assigning a value 0 to all other observations.

In connection with the discussion of FIG. 1, it is noted that the original time series S, at 103, may come from any real-world application or, in an embodiment, the original time series S may be obtained by converting a drawing of a curve to a time series. In this regard, a significant issue that arises when using off-the-shelf packages, such as ScikitMultiflow and MOA, occurs when it is necessary to generate a whole and diverse set of curves, which requires an expensive experimental setting on many hyperparameter values to find the most appropriate set of curves. Moreover, incremental drift is difficult to achieve without fine-tunning in these packages. Notwithstanding, such packages may find application in some limited circumstances. For example, in an embodiment, a package may be feasible for use where only a single initial instance, that is, a single curve, is needed. Examples of the MOA and ScikitMultiflow packages are respectively disclosed in [1] G. H. R. K. B. P. Albert Bifet, “MOA: Massive Online Analysis,” Journal of Machine Learning Research, vol. 11, pp. 1601-1604, 2010, and [2] J. Montiel, J. Read, A. Bifet e T. Abdessalem, “Scikit-multiflow: a multi-output streaming framework,” The Journal of Machine Learning Research, vol. 19, nº 72, pp. 1-5, 2018, both of which are incorporated herein in their respective entireties.

If no initial curve is provided, if the user does not have a sample input curve to be used as reference, an embodiment may generate a new curve using a draw-to-curve method. In an embodiment, and with reference now to FIG. 2, an augmentation pipeline, such as the pipeline 100 for example, may deal with two types of drifts, namely, sudden drift, and incremental drift. In the graphs 200 in FIG. 2, drift is shown on the vertical axis, and time on the horizontal axis. Particularly, and in a binary-class setting, (a) is an example of sudden drift, and (b) is an example of incremental drift.

### B.1 Example Draw-to-Curve Method

As noted earlier, if no curve is available, such as at 102 (see FIG. 1), an embodiment may employ a draw-to-curve method. An embodiment may assume the availability of a user-provided, possibly hand drawn, drawing or sketch of a curve that captures the intuition of that user concerning a relevant drift pattern in the domain of interest. For example, such a sketch may indicate sudden drift, or incremental drift, examples of which are disclosed in FIG. 2.

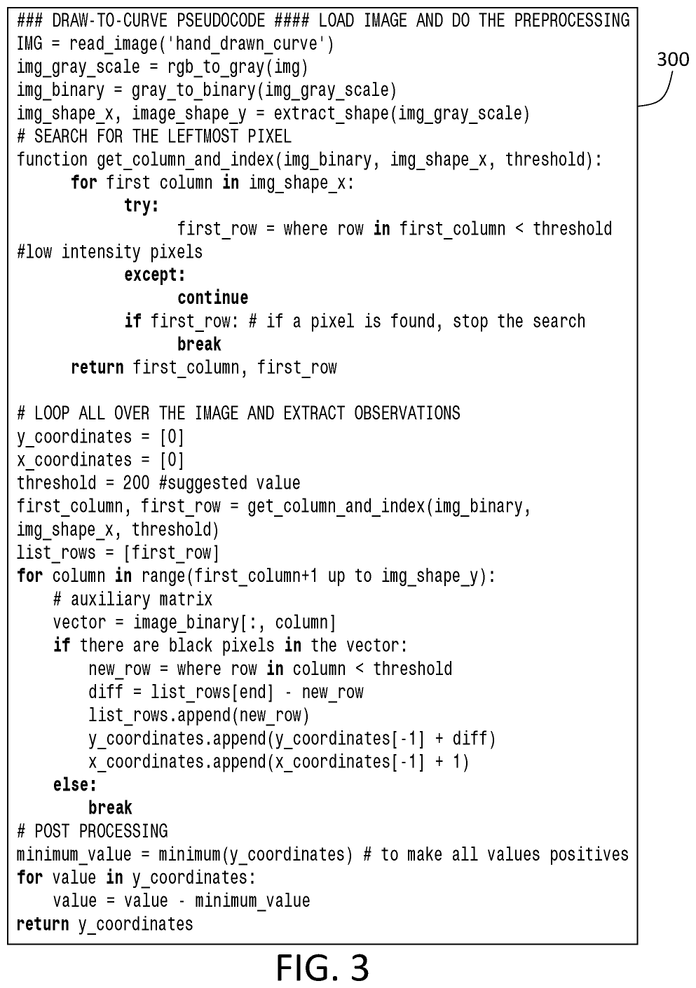

In an embodiment, the drawing, which may be provided in any resolution, may be converted to gray scale, and subsequently binarized. The top left-most pixel in the gray scale rendering may found, and set as the starting point of the time series. Then, an incremental procedure may begin from the left-most pixel, in a column-wise manner. If a non-background pixel, which may be white, is found, the difference in magnitude between the last pixel checked and the new pixel may then be stored. The incremental procedure may end when no more pixels are found. Next, since, in an embodiment, only positive drift values are of interest, the minimum drift value may be found and used to make all drift values positive by summing everything with this minimum drift value. Sample pseudocode 300 for this example draw-to-curve algorithm is disclosed in FIG. 3.

Note that the draw-to-curve algorithm may be further adapted to cases with non-white background, as well as for other particular cases, for example, for dealing with particular image formats such as .jpeg, .png, and others. Any such variations are expected to be straightforward given the core algorithm provided above. Moreover, the results of the execution of the draw-to-curve algorithm above may be stored in an appropriate data format for later use, rather than just kept in memory. For example, such results may be stored as a comma-separated value (CSV) file.

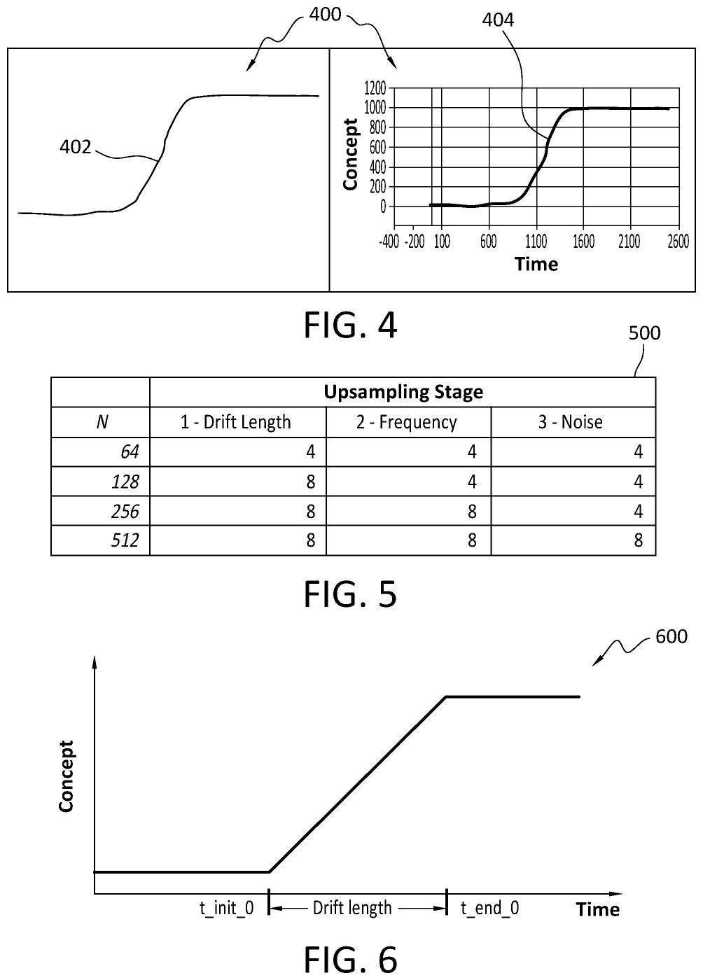

With reference now to FIG. 4, there is disclosed a set of graphs 400 that include an example of a drawing 402 depicting an incremental drift scenario, which may be hand drawn, such as may be provided by a domain specialist user. The drawing 402 may be processed according to an embodiment of the draw-to-curve algorithm, to generate a plot 404 of a time series that corresponds to the drawing 402. Note that the depiction, in FIG. 4, of a monotonically increasing curve serves merely to illustrate the capability of an embodiment of the draw-to-curve algorithm and is not intended to limit the scope of the invention in any way. Rather, any kind of curve drawn may be captured by the draw-to-curve algorithm and used to render a time series, as demonstrated by the other examples disclosed herein.

### B.2 Example Upsampling Stages

When applying upsampling stages, such as the examples disclosed in FIG. 1, an embodiment may generate a suitable number of new sampled series at each stage to ultimately obtain the number of curves N requested by the user. Methods to determine these numbers dynamically may be implemented to intelligently define the progression until N is reached. In an embodiment, and for the sake of simplicity, fixed values may be sufficient, particularly since overshooting may not be a material problem. With reference now to the example table 500 in FIG. 5, possibilities of combinations for the number of sample series generated at each stage are shown for some example values of N. As shown, the number of curves N may be found as the product of three variables, namely, the variables drift length (1), frequency (2), and noise (3). Thus, and as shown in the table 500, for a drift length value of 4, a frequency value of 4, and a noise value of 4, the corresponding number of curves N needed would be 4×4×4, that is, 64.

In an embodiment, if intermediate problems are to be generated, it may suffice to

generate the next-largest amount N and discard the excess number, since the outputs may be stochastically generated. For generating more than 512 curves, an embodiment of the method may be applied iteratively, or new fixed combinations of the values for drift length, frequency, and noised, may be defined. Furthermore, although one embodiment may use random transformation values for the upsampling of the curves, it is also possible for a user to inject desired transformation values for the transformations in all steps, as long as those values are distinct and follow a stipulated upsampling progression, such as in the example of the table 500.

### B.3 Drift Length

As used herein, drift length refers to the amount of time that it takes for the behavior of an ML model to completely change from one class to another, as shown in the example graph 600 in FIG. 6. The drift length that differentiates a sudden drift from an incremental drift may be arbitrary and bounded to the application, or model. In an embodiment, only the sudden or incremental drift types are considered, for use with basic drift detectors, such as ADWIN. Further information in this regard is disclosed in OpenML, “covertype,” 2015. [Online]. Available: https://www.openml.org/search?type=data&status=active&id=1596&sort=runs. [Acesso em 14 Oct. 2022], which is incorporated herein in its entirety by this reference.

An embodiment may assume that the parameters for the drift detection method are properly set, and the output of the drift upsampling pipeline is coherent to the drift presented by the curve, that is, the output of the drift upsampling pipeline refers to the start, and to the end, of the drift that has occurred. At this first stage, different drift lengths may be generated according to a distribution, which may be specified by a user. In an embodiment, this distribution may be normal, or uniform.

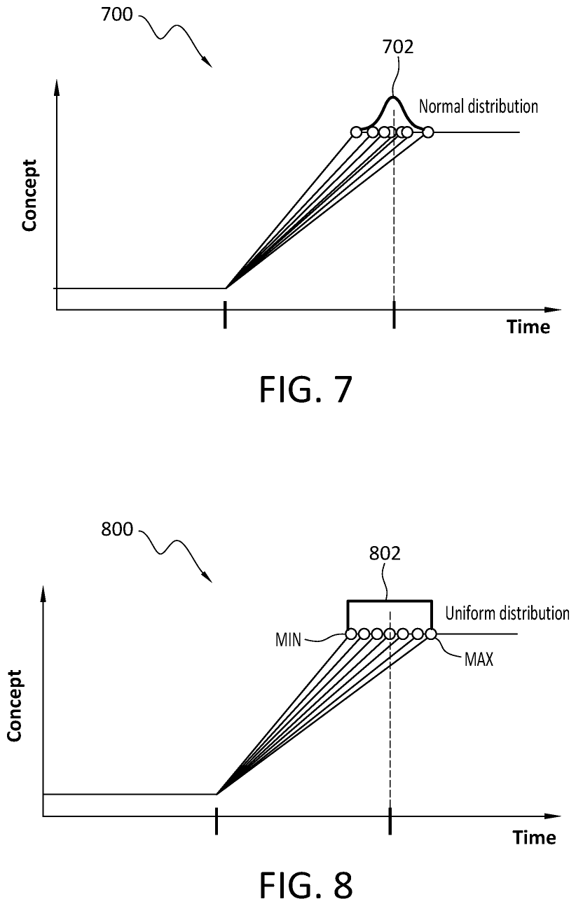

For example, and with reference now to the example graphs 700 and 800 of FIGS. 7 and 8, respectively, in a normal distribution according to one embodiment, the sampling may consider the initial length as the mean value and may assume a certain value of the standard deviation. This case is represented in FIG. 7, which discloses multiple generations of drift length for a normal distribution 702. The standard deviation of the normal distribution 702 may be determined by a user. Thus, the normal distribution employed in an embodiment may be wider, or narrower, than the normal distribution 702, which is provided only by way of example, and not limitation.

With reference now to FIG. 8, there is disclosed a graph 800 that comprises multiple generations of drift length for a uniform distribution 802. For the uniform distribution 802, the distribution may be randomly sampled between a fixed min-max interval, which may be user-defined. By default, the standard deviation for a normal distribution may, in an embodiment, be 20% of the original drift length and the min-max interval of ±30% of the original drift length.

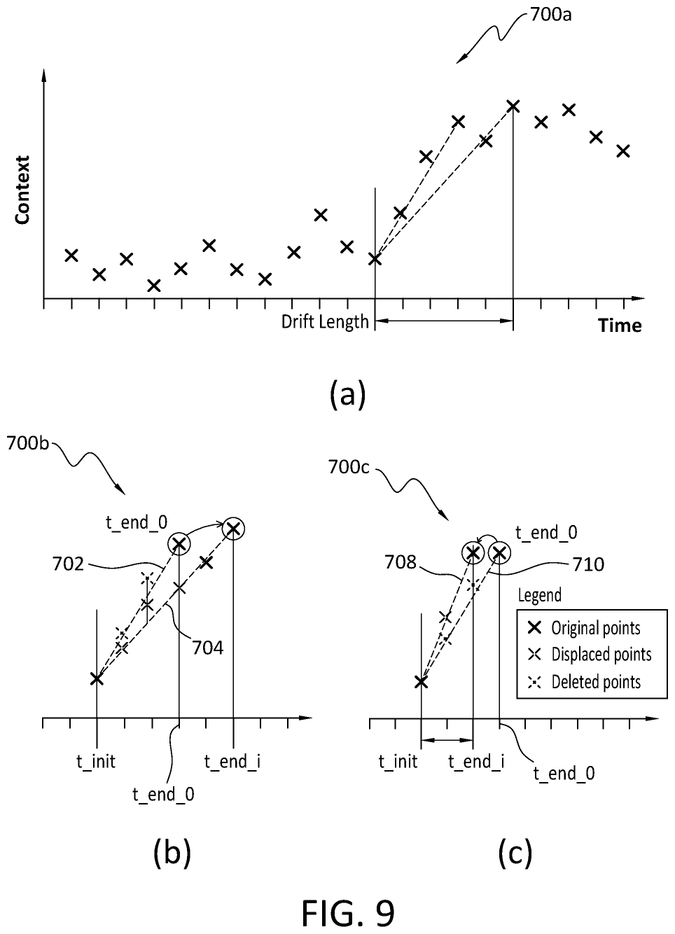

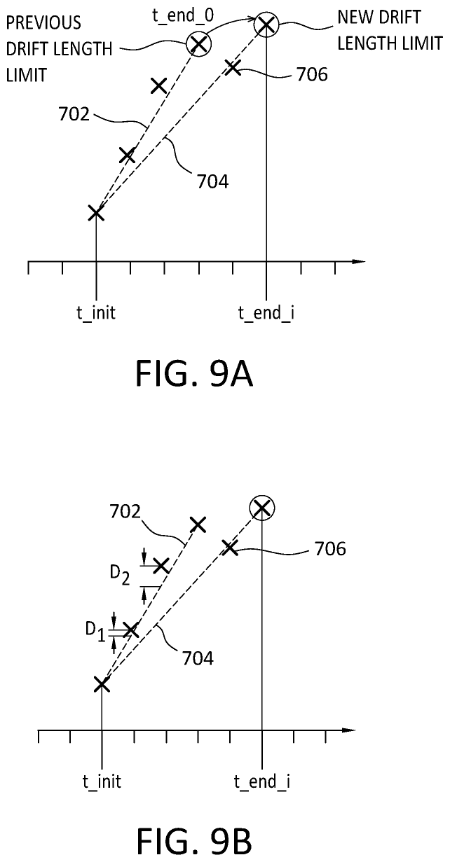

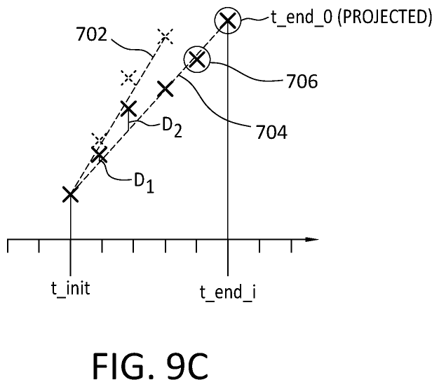

Turning next to the examples of FIG. 9, there is disclosed a given drift occurrence 700a, and two different scenarios for drift length augmentation for (a) a given curve and the demonstration of procedures of (b) enlarging 700b, and (c) shortening 700c, the drift length. With FIG. 9 in view, and directing attention to FIGS. 9a, 9b, and 9c, as well, further details are provided concerning some example procedures for lengthening, and shortening, a drift length.

A procedure according to one embodiment may start by applying the drift detection to the original curve, represented at 700a, to obtain the limits of the drift length interval, namely (t_init, and t_end_0). If the timestamp t_end_i coming from the distribution is smaller than t_end_0 (see 700c) the drift length may be shortened, otherwise the drift length may be enlarged (see 700b). An embodiment may call t_end_i, where i is a pointer to the list of timestamps drawn from the desired distributions.

Next, and as shown at 700b, and FIG. 9a, two lines may be plotted, namely, a first line 702 connecting t_init and t_end_0, that is, the original drift length limits, and a second line 704 connecting t_init and a projection of t_end_0 towards the new drift length limit, namely t_end_i. In this example, the line 702 represents the plotted line for the original boundary, and the line 704 represents the plotted line for the new limits.

Next, and with particular reference now to the example of FIG. 9b, respective vertical distances D₁ and D₂ between points within the original drift length boundaries (t_init, and t_end_0) and the plotted line 702 are calculated, and may be stored. As will be appreciated, the line 702 may thus comprise a best-fit line for the points within the original drift length boundaries and, as such, lines within the original drift length boundaries may or may not fall on the line 702.

After vertical distances D₁ and D₂ have been determined, and with reference now to the example of FIG. 9c, those points may then be vertically displaced towards the other plotted line 704, considering those vertical distances D₁ and D₂ calculated earlier. The original limit t_end_0, is projected to the line 704, and points, such as point 706 (see also, FIGS. 9a and 9b), that were not within the original boundaries are kept as they are.

Returning once more to the example of 700c, the procedure for shortening a drift length may be similar to the procedure for elongating a drift length, although the shortening process may not involve the definition or use of points in-between the old and the new drift length boundaries. As shown in the example of 700c, a first line 708, and second line 710 maybe plotted. The first line 708 may connect t_init to t_end_0 (the old, or initial, end) and the second line 710 may connect the new_y, that is, t_end_i, to t_init. Vertical distances from observations within t_init and y, that is, t_end_0, to this line 710 may be calculated and stored, similar to the procedure described in connection with FIGS. 9a-9c. These observations may then be displaced following these distances in relation to the line 708 connecting y_init and new_y, that is, t_end_i.

Briefly summarized then, FIGS. 9 through 9c disclose example processes and associated operations for transforming a time series by lengthening, or shortening, a drift length. As noted elsewhere herein, a drift length modification process may comprise a stage, such as a first stage, of an upsampling procedure.

### B.4 Frequency

It was noted in the discussion of FIG. 1 that another upsampling stage that may be applied to a drift pattern 0 is frequency. As used herein, ‘frequency’ embraces the number of points between two sequential timestamps. For an example, 10 observations acquired within one second corresponds to a frequency of 1/10, or 0.1 Hz. This stage (112 in FIG. 1) may follow the drift length alteration to not de-characterize the timestamps that constitutes the drift interval.

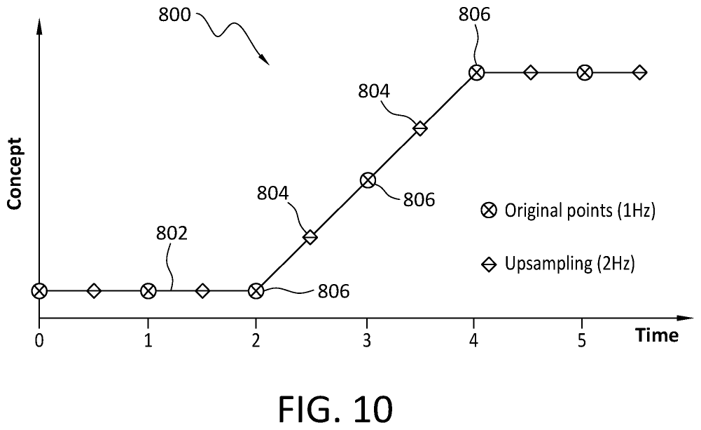

During the frequency upsampling stage, the original may be is obtained and, once more, curves from the drift length stage (110 in FIG. 1) may have their respective frequencies randomly changed. This randomization may also be carried out using absolute even values from a normal or uniform distribution. This means that, in an embodiment, the frequency is always increased by a factor of 2, 4, 6 . . . n. FIG. 10 discloses an example process of points upsampling. Particularly, FIG. 10 comprises a graph 800 of a drift curve 802 indicating an incremental drift beginning at time T2 and ending at time T4. This example indicates a doubling of the frequency of a series with original frequency equals 1 Hz, considering a period of 1 s. The example process depicted in FIG. 10 is carried out by the addition of an observation 804 between each pair of consecutive original points 806 using a simple mean value.

Notice that, in the example of FIG. 8, it is not possible to reduce the frequency without de-characterizing the transition that occurs between time T2 and time T4. That is, for example, if the frequency of the drift curve 802 were reduced by removing point 806 at time T3, there would then be no way to know with particularity what happened between time T2 and time T4, as the change in the drift curve could have been either incremental, or sudden. On the other hand, when the point 806 at time T3 is included, it is apparent that the drift from T2 to T4 was incremental in nature, rather than sudden.

### B.5 Noise

At this stage (114 in FIG. 1), the first operation may be to calculate the native noise of the curve. An embodiment may comprise the following procedure: [1] smooth the curve using a low-pass filter (an example of which is disclosed in OpenML, “pokerhand,” 2014. [Online]. https://www.openml.org/search?type=data&status=active&id=155&sort=runs. [Acesso em 14 Oct. 2022], which is incorporated herein in its entirety by this reference); and [2] calculate the absolute mean error between the smoothed curve and the original curve to yield the original noise R.

This noise R then becomes the mean value of a normal distribution, or the central point of a uniform distribution. An embodiment may randomize the curves coming from stage 2 (114 in FIG. 1) using one of these distributions up to the final number of curves N. By default, the standard deviation may be 20% of R, and min-max may be ±50% of R. A rule may be implemented to make noise, tuning the noise to be more expressive. If the previous new observation is lower in magnitude than the ongoing observation, the alteration is positive. If the previous new observation is greater than the ongoing observation, the alteration is negative. For such a procedure, it may be simply a matter of changing the signal from the value drawn from the distribution.

### B.6 Example

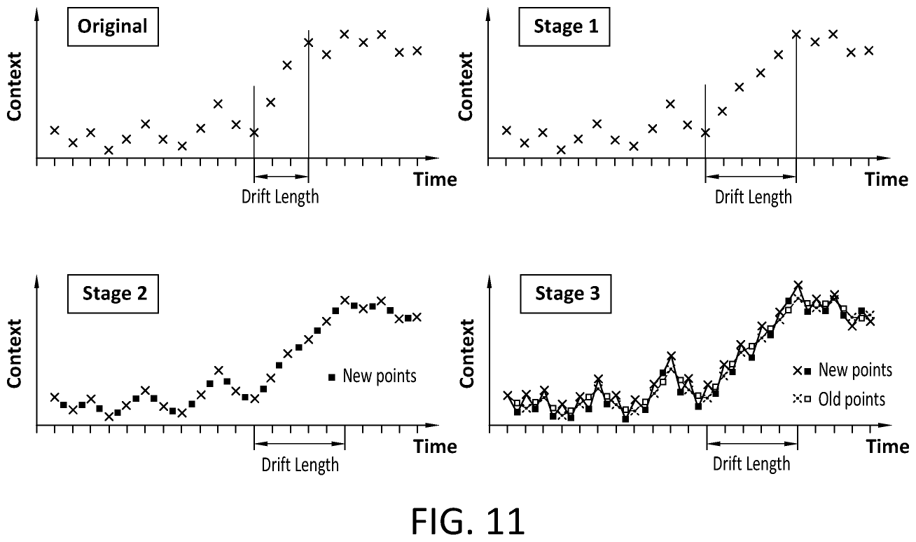

With reference next to FIG. 11, an example hypothetical progression of a curve augmentation is disclosed. Note that the ‘stage’ references in FIG. 11 correspond to the ‘stage’ elements disclosed in the example of FIG. 1. As shown in FIG. 1, stage 1 operates to enlarge the drift length of the original curve. From the resulting enlarged curve, the frequency is doubled at stage 2 by adding an observation between each existing pair of observations. Finally, noise is increased in stage 3.

### C. Example Methods

It is noted with respect to the disclosed methods, including the example methods of

FIGS. 1, 3, 9-9c, 10 and 11, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### D. Further Example Embodiments

Following are some further example embodiments of the invention. These are

presented only by way of example and are not intended to limit the scope of the invention in any way.

Embodiment 1. A method, comprising: receiving, by a drift upsampling pipeline, input comprising: a time series of data expressed as an initial drift curve; and, a drift characterization of the drift curve; performing, by the drift upsampling pipeline, a first upsampling stage on the time series of data to generate a first family of new drift curves based on the drift characterization of the initial drift curve; performing, by the drift upsampling pipeline, a second upsampling stage to determine respective frequencies of the first family of new drift curves to generate a second family of new drift curves with the respective frequencies; performing, by the drift upsampling pipeline, a third upsampling stage on respective noise levels of the second family of new drift curves to generate a third family of new drift curves with new respective noise levels; and outputting, by the drift upsampling pipeline, the third family of new drift curves.

Embodiment 2. The method as recited in any of the preceding embodiments, wherein the initial drift curve is received from a user.

Embodiment 3. The method as recited in any of the preceding embodiments, wherein the initial drift curve was generated by manipulation of a hand-drawn drift curve.

Embodiment 4. The method as recited in any of the preceding embodiments, wherein the drift characterization of the initial drift curve comprises an interval of a drift period of the initial drift curve.

Embodiment 5. The method as recited in any of the preceding embodiments, wherein a number N of drift curves in the third family of new drift curves is specified by a user.

Embodiment 6. The method as recited in any of the preceding embodiments, wherein the first upsampling stage comprises defining a respective drift length for each of the curves in the first family of new curves.

Embodiment 7. The method as recited in embodiment 6, wherein the respective drift lengths are each either shorter, or longer, than a drift length of the initial drift curve.

Embodiment 8. The method as recited in any of the preceding embodiments, wherein the respective frequencies for the drift curves in the second family of new drift curves are higher than the frequency of the initial drift curve.

Embodiment 9. The method as recited in any of the preceding embodiments, wherein the new respective noise levels for the drift curves in the third family of new drift curves are each higher than previous respective noise levels for the drift curves in the second family of new drift curves.

Embodiment 10. The method as recited in any of the preceding embodiments, wherein the initial drift curve exhibits either an incremental drift, or a sudden drift.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### F. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

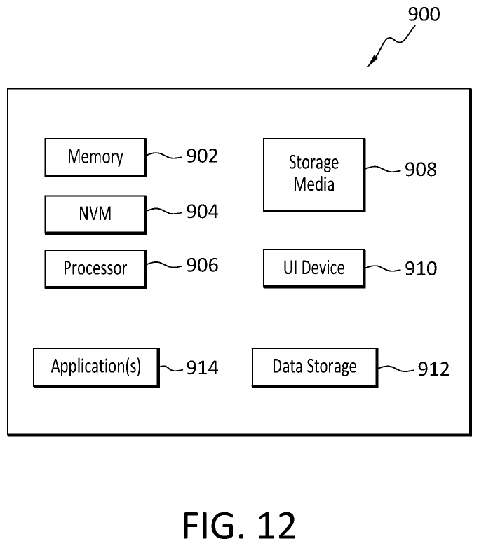

With reference briefly now to FIG. 12, any one or more of the entities disclosed, or implied, by FIGS. 1-11, and/or elsewhere herein, may take the form of, or include, or be implemented on, or hosted by, a physical computing device, one example of which is denoted at 900. As well, where any of the aforementioned elements comprise or consist of a virtual machine (VM), that VM may constitute a virtualization of any combination of the physical components disclosed in FIG. 12.

In the example of FIG. 12, the physical computing device 900 includes a memory 902 which may include one, some, or all, of random access memory (RAM), non-volatile memory (NVM) 904 such as NVRAM for example, read-only memory (ROM), and persistent memory, one or more hardware processors 906, non-transitory storage media 908, UI device 910, and data storage 912. One or more of the memory components 902 of the physical computing device 900 may take the form of solid state device (SSD) storage. As well, one or more applications 914 may be provided that comprise instructions executable by one or more hardware processors 906 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
receiving, by a drift upsampling pipeline, input comprising: a time series of data expressed as an initial drift curve; and, a drift characterization of the drift curve;
performing, by the drift upsampling pipeline, a first upsampling stage on the time series of data to generate a first family of new drift curves based on the drift characterization of the initial drift curve;
performing, by the drift upsampling pipeline, a second upsampling stage to determine respective frequencies of the first family of new drift curves to generate a second family of new drift curves with the respective frequencies;
performing, by the drift upsampling pipeline, a third upsampling stage on respective noise levels of the second family of new drift curves to generate a third family of new drift curves with new respective noise levels; and
outputting, by the drift upsampling pipeline, the third family of new drift curves.

2. The method as recited in claim 1, wherein the initial drift curve is received from a user.

3. The method as recited in claim 1, wherein the initial drift curve was generated by manipulation of a hand-drawn drift curve.

4. The method as recited in claim 1, wherein the drift characterization of the initial drift curve comprises an interval of a drift period of the initial drift curve.

5. The method as recited in claim 1, wherein a number N of drift curves in the third family of new drift curves is specified by a user.

6. The method as recited in claim 1, wherein the first upsampling stage comprises defining a respective drift length for each of the curves in the first family of new curves, relying on an appropriate drift detector.

7. The method as recited in claim 6, wherein the respective drift lengths are each either shorter, or longer, than a drift length of the initial drift curve.

8. The method as recited in claim 1, wherein the respective frequencies for the drift curves in the second family of new drift curves are higher than the frequency of the initial drift curve.

9. The method as recited in claim 1, wherein the new respective noise levels for the drift curves in the third family of new drift curves are each higher than previous respective noise levels for the drift curves in the second family of new drift curves.

10. The method as recited in claim 1, wherein the initial drift curve exhibits either an incremental drift, or a sudden drift.

11. A non-transitory storage medium having stored therein instructions that are executable by one or more hardware processors to perform operations comprising:
receiving, by a drift upsampling pipeline, input comprising: a time series of data expressed as an initial drift curve; and, a drift characterization of the drift curve;
performing, by the drift upsampling pipeline, a first upsampling stage on the time series of data to generate a first family of new drift curves based on the drift characterization of the initial drift curve;
performing, by the drift upsampling pipeline, a second upsampling stage to determine respective frequencies of the first family of new drift curves to generate a second family of new drift curves with the respective frequencies;
performing, by the drift upsampling pipeline, a third upsampling stage on respective noise levels of the second family of new drift curves to generate a third family of new drift curves with new respective noise levels; and
outputting, by the drift upsampling pipeline, the third family of new drift curves.

12. The non-transitory storage medium as recited in claim 11, wherein the initial drift curve is received from a user.

13. The non-transitory storage medium as recited in claim 11, wherein the initial drift curve was generated by manipulation of a hand-drawn drift curve.

14. The non-transitory storage medium as recited in claim 11, wherein the drift characterization of the initial drift curve comprises an interval of a drift period of the initial drift curve.

15. The non-transitory storage medium as recited in claim 11, wherein a number N of drift curves in the third family of new drift curves is specified by a user.

16. The non-transitory storage medium as recited in claim 11, wherein the first upsampling stage comprises defining a respective drift length for each of the curves in the first family of new curves.

17. The non-transitory storage medium as recited in claim 16, wherein the respective drift lengths are each either shorter, or longer, than a drift length of the initial drift curve.

18. The non-transitory storage medium as recited in claim 11, wherein the respective frequencies for the drift curves in the second family of new drift curves are higher than the frequency of the initial drift curve.

19. The non-transitory storage medium as recited in claim 11, wherein the new respective noise levels for the drift curves in the third family of new drift curves are each higher than previous respective noise levels for the drift curves in the second family of new drift curves.

20. The non-transitory storage medium as recited in claim 11, wherein the initial drift curve exhibits either an incremental drift, or a sudden drift.
